(19) United States
(12) Patent Application Publication
(10) Pub. No.: US 2010/0026634 A1
(43) Pub. Date: Feb. 4, 2010

(54) Writeable and Erasable Display Units

(75) Inventors: Tzeng-Shii TSAI, Jhudong Township (TW); Jia-Xing LIN, Jhudong Township (TW); Da-Wei LEE, Taipei City (TW); Tai-Ann CHEN, Sindian City (TW)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: INDUSTRIAL TECHNOLOGY RESEARCH INSTITUTE, Hsinchu (TW)

(21) Appl. No.: 12/183,059

(22) Filed: Jul. 30, 2008

(51) Int. Cl. G06F 3/041

(52) U.S. Cl. 345/173

(57) ABSTRACT

A display unit comprises a display medium which is writable, erasable and displayable of an image and a rotatable writehead with a number of loop conductors parallel with each other. The display medium is capable of maintaining a written image without power. In operating of writing on the display medium, the loop conductors apply an electric field to a particular area of the display medium, changing the optical state of the particular area of the display medium. In operating of writing on the display medium, there is no relative motion between the display medium and the writehead.

### BACKGROUND

1. Field

This application relates to a display unit, and more particularly, to a writable and erasable bistable display unit, and a method of writing on the bistable display of the unit.

### BACKGROUND OF THE INVENTION

Visual information has been presented through the use of inks and papers. However, the information recorded on paper is not changeable. Display technologies, such as cathode ray tubes (CRTs), liquid crystal displays (LCDs) or plasma displays, may enable information to be easily rewritten or erased, and provide a large-sized and color display of dynamic and video-capable information. However, for these types of display units, loss of power may result in loss of information. In other words, these display units require a constant power to maintain the displayed information.

In recent years, bistable display technology has been developed to offer display units with recording media which possess the stability advantage of paper as well as the updateable capabilities of a conventional display. The recording medium in a bistable display may be writable by applying, for example, an electric field or magnetism. The information may be continuously displayed even when the electric field or magnetism is removed. Applying a reset waveform of electric field or demagnetizing the residual magnetism may erase the information.

In addition, many applications of flexible display have been developed recently. For example, U.S. Patent Publication No. 2003/0071800 proposed a portable electronic reading apparatus for an e-book application. U.S. Pat. No. 6,498,597 proposed a continuous scroll-type display. U.S. Patent Publication No. 2006/0132429 to Ricks et al. proposed a loop-type scrolling bistable display for a signage board application. One of the drawbacks of these proposals is that the surface of the writehead or the display medium would be gradually wear out or scratched after a period of writing process. That results from the fact that there exist relative movement between the writehead and the display medium.

### BRIEF SUMMARY

One example consistent with the invention provides a display unit which comprises a display medium which is writable, erasable and displayable of an image and a rotatable writehead with a number of loop conductors parallel with each other. The display medium is capable of maintaining a written image without power. In operating of writing on the display medium, the loop conductors apply an electric field to a particular area of the display medium, changing the optical state of the particular area of the display medium. In operating of writing on the display medium, the writehead rotates with the display medium moving in the same direction synchronously, while there is no relative motion between the display medium and the writehead.

In another example, a display unit comprises a display medium which is writable, erasable and displayable of an image, a rotatable writehead having a body and a support unit. Portions of the writehead are covered with a number of loop conductors parallel with each other. The loop conductors provide an electric field to a particular area of the display medium. The support unit and the writehead are located on both sides of the display medium. There is no relative motion between the display medium and the writehead in operation of writing on the display medium.

Another example consistent with the invention provides a method of writing on a display which comprises providing a display medium which is writable, erasable and continuously displayable of an image, providing a rotatable writehead with a number of loop conductors in parallel with each other, writing on a particular area of the display medium by applying an electric field to the area, rotating the writehead in a way that no relative motion occurs between the display medium and the writehead.

It is to be understood that both the foregoing general description and the following detailed description are exemplary and explanatory only and are not restrictive of the invention, as claimed.

### BRIEF DESCRIPTION OF THE DRAWINGS

The foregoing summary, as well as the following detailed description of the invention, will be better understood when read in conjunction with the appended, exemplary drawings. It should be understood, however, that the invention is not limited to the precise arrangements and instrumentalities shown.

In the drawings:

FIG. 1 is an exemplary side view of a display unit in examples consistent with the present invention;

FIG. 2 is an exemplary cross-sectional view of the operation of writing on a display unit in examples consistent with the present invention;

FIG. 3 is an exemplary side view of a display unit in examples consistent with the present invention;

FIG. 4 is an exemplary side view of a display unit in examples consistent with the present invention;

FIG. 5 is an exemplary side view of a display unit in examples consistent with the present invention; and

FIGS. 6(a) and 6(b) are exemplary cross-sectional views of the application of a display unit in examples consistent with the present invention.

### DETAILED DESCRIPTION

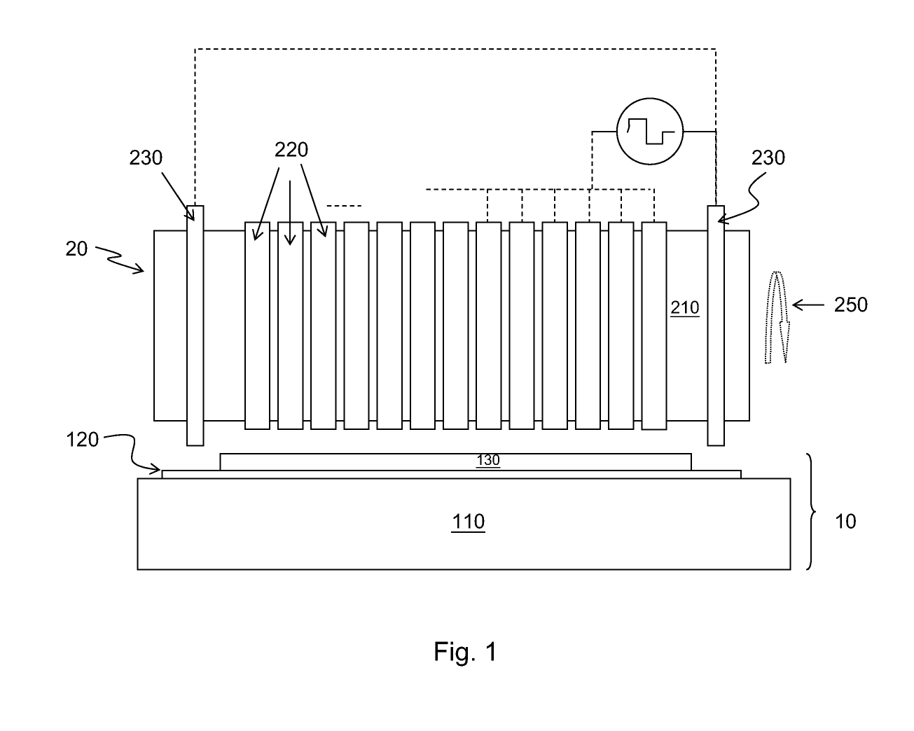

FIG. 1 shows an exemplary side view of a display unit in examples consistent with the present invention. The display unit of FIG. 1 may include a display medium 10 and a writehead 20. The display medium may be made of at least one of a cholesteric liquid crystal imaging film, an electrophoretic imaging film and an electrowetting imaging film.

Referring to FIG. 1, the display medium 10 may include a substrate 110, a layer 120 of a first electrode, and a layer 130 of a bistable material. The substrate 110 may be made of a flexible material or a rigid material. For example, the substrate 110 may be made of glass, plastic, metallic, ceramic, or polymeric materials. The substrate 110 may be transparent or non-transparent, depending on the application design of the view side. The first electrode layer 120 may be coated on the substrate 110. The first electrode layer 120 may be an one-piece layer or may be patterned into parallel lines, each forming a separate electrical contact. The bistable material layer 130 may be coated on the first electrode layer 120 in a way that portions of the first electrode layer 120 are exposed from the bistable material layer 130. The bistable material layer 130 may be made of a material that is capable of maintaining a given state indefinitely after an electric field is removed. In one example, the bistable material layer 130 may be made of electrochemical materials, electrophoretic materials, eletrochromic materials, magnetic materials or liquid crystal materials. No display pixel is required to be defined on the display medium 10.

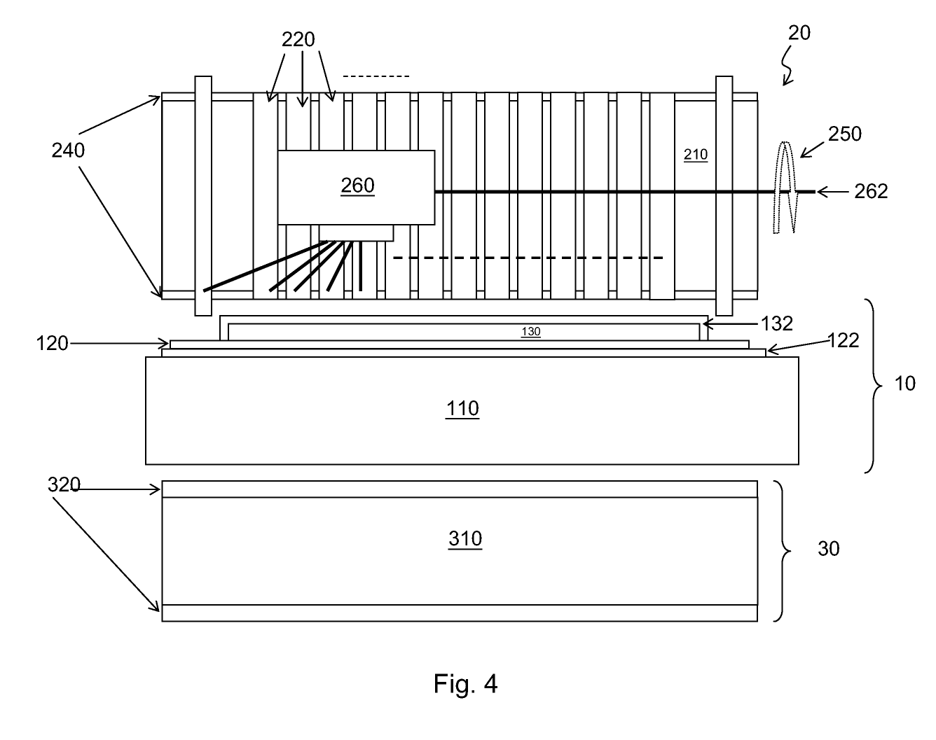

Referring again to FIG. 1, the writehead 20 may have a body 210 which may be rotatable along the direction 250. In one example, the rotatable body 210 may be in cylindrical, hexagonal cylindrical, octagonal or polygonal cylindrical shape. The rotatable body 210 may be centrically wound with a number of first loop conductors 220 and a number of second loop conductors 230. The first loop conductors 220 and the second loop conductors 230 may be arranged in a way such that, in operation of the display unit, the first loop conductors 220 may contact with the bistable material layer 130 and the second loop conductors 230 may contact with the first electrode layer 120. The writehead 20 may include a processing unit 260 (shown in FIG. 4) which is electrically connected to each of the first loop conductors 220 and the second loop conductors 230. Signals designating the rows of a column to be written on the display medium 10 may be transmitted to the processing unit 260 via wired or wireless connection. According to the signals, the processing unit 260 may provide power supply to the designated first loop conductors 220 and the second loop conductors 230. Since the second loop conductors 230 are in contact with the first electrode layer 120, the first electrode layer 120 and the designated first loop conductors 220 may provide for application of electric field of various intensity and duration to the designated areas of the bistable material layer 130. The state of these areas may be changed from a reflective state to a transmissive state or vice versa, and thereby writing messages on the display medium 10. Since the bistable materials may maintain a given state indefinitely after the electric field is removed, the display medium 10 may maintain a desired written message without power.

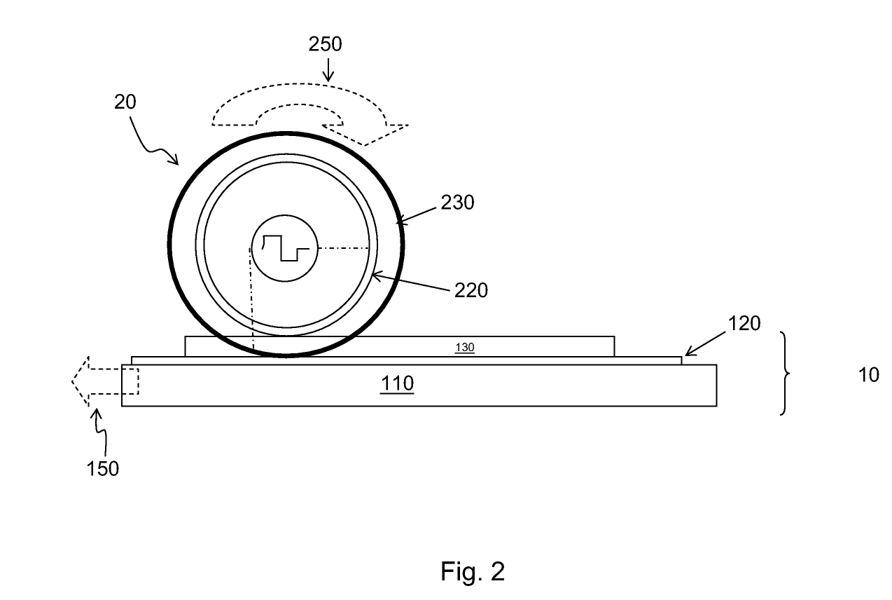

FIG. 2 shows an exemplary cross-sectional view of the operation of a display unit in examples consistent with the present invention. Referring to FIG. 2, the writehead 20 may be coupled to the display medium 10 in a way that the first loop conductors 220 are in contact with the bistable material layer 130 and the second loop conductors 230 are in contact with the first electrode layer 120. In operation of writing on the display medium 10, no relative motion may occur between the display medium 10 and the writehead 20. In one example, the writehead 20 may rotate along the direction 250 while the display medium 10 may move in the direction 150 at the same speed as the peripheral speed of rotation of the writehead 20. In another example, while the display medium 10 may stand still, the writehead 20 may rotate along the direction 250, and at the same time, move in the opposite direction of 150 at the same speed as its peripheral speed of rotation. As such, there is no relative motion between the display medium 10 and the writehead 20. In addition, rotation of the writehead may be continuous or step-by-step in angle.

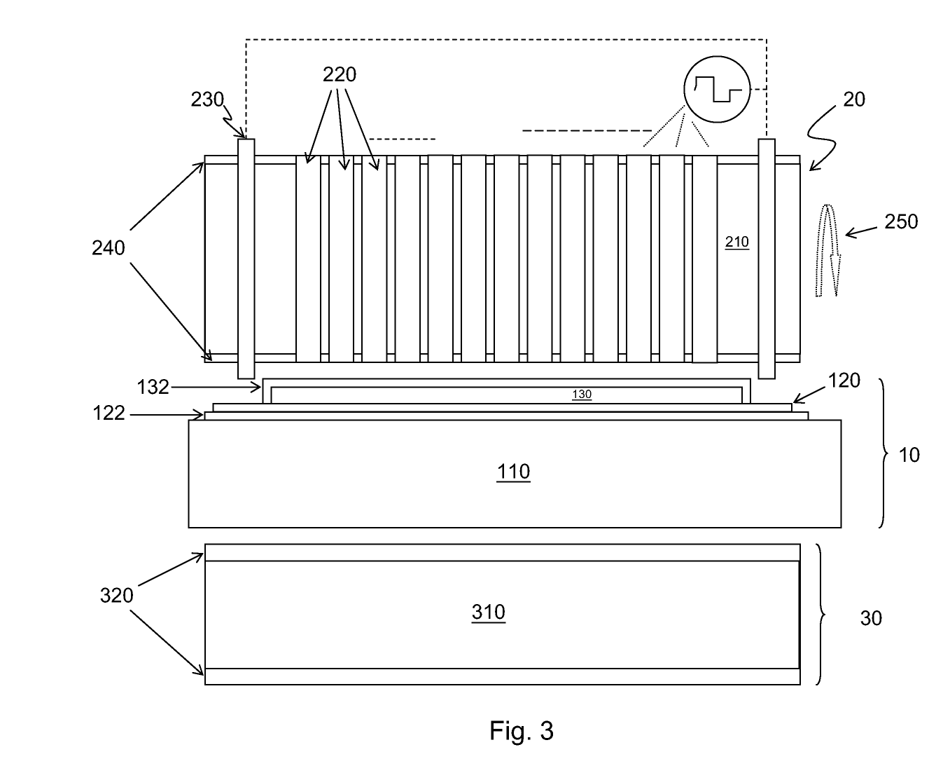

FIG. 3 is an exemplary side view of a display unit in examples consistent with the present invention. Similar to FIG. 1, the display unit of FIG. 3 may include a display medium 10 and a writehead 20. In addition to the layers of the display medium 10 of FIG. 1 described above, the display medium 10 of FIG. 3 may further include an absorbing layer 122 underneath the first electrode layer 120. The absorbing layer 122 may be in color for absorbing light that passes through the first electrode layer 120. As such, the quality of the image on the display medium 10 may be improved. In one example, the first electrode layer 120 may incorporate the absorbing layer 122 to the bottom of its layer. The display medium 10 may further include a protection layer 132 coated over the bistable material layer 130. In one example, the protection layer 132 may be a non-metal, optical transparent layer. For other examples, the absorbing layer 122 may be arranged above the first electrode layer 120 or above the display medium layer 10. Moreover, the absorbing layer 122 may also be incorporated into the first electrode layer 120 or the protection layer 132. In addition to the structure of the writehead 20 of FIG. 1 described above, the writehead 20 of FIG. 3 may further include insulation layers 240 around the body 210 in an arrangement that, for the spaces between each first loop conductor, the body 210 is covered with insulation layer 240 to prevent short circuit. The insulation layers 240 may be made of a resistive material for rub resistance. The display unit of FIG. 3 may further include a support unit 30 located on a side of the display medium 10 opposite to the side where the writehead 20 is located. The support unit 30 may provide a support in operation of writing on the display medium 10. In one example, the support unit 30 may rotate as the same speed as the writehead 20. The support unit 30 may include a rotatable supporting roller 310. In one example, the supporting roller 310 may be in cylindrical, hexagonal cylindrical or octagonal cylindrical shape. The supporting roller 310 may be coated with a layer 320 of an elastic and high-friction material, such as rubber.

FIG. 4 is an exemplary side view of a display unit in examples consistent with the present invention. Similar to FIG. 3, the display unit of FIG. 4 may include a display medium 10, a writehead 20 and a support unit 30. The display unit of FIG. 4 may further include a processing unit 260 which may be provided in the interior of the rotatable body 210, and may be electrically connected to each first loop conductor 220 and second loop conductor 230. The processing unit 260 may receive signals that designate the rows of a column to be written on the display medium 10 by cable 262, which may be provided inside the rotation axis of the rotatable body 210, or by wireless connection. According to the signals, the processing unit 260 may provide power supply to the designated first loop conductors 220 and the second loop conductors 230. Since the second loop conductors 230 are in contact with the first electrode layer 120, an electric field may be established between the first electrode layer 120 and the designated first loop conductors 220. As such, the state of the areas of the display medium 10 between the first electrode layer 120 and the designated first loop conductors 220 may be changed, and thereby writing messages on the designated areas of the display medium 10.

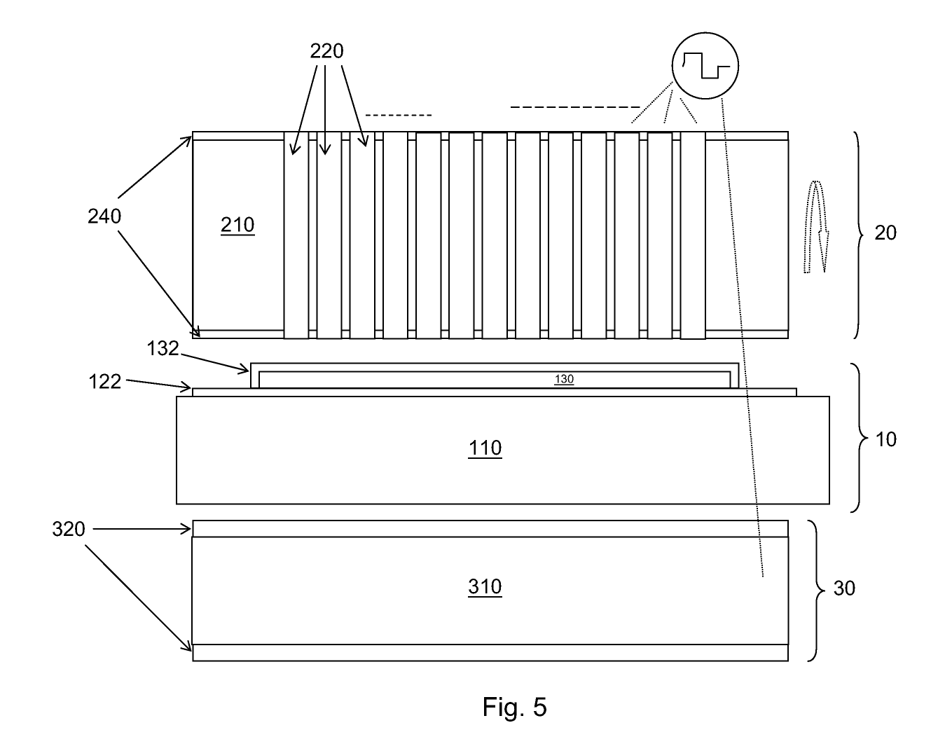

FIG. 5 is an exemplary side view of a display unit in examples consistent with the present invention. The display unit of FIG. 5 is similar to the display unit of FIG. 3, except that the display unit of FIG. 5 does not include the first electrode layer 120 and the second loop conductors 230. In this particular embodiment, the supporting roller 310 may be made of a conductive material. The supporting roller 310 and the first loop conductors 220 may be connected to a power supply, for example, via a processing unit 260, to establish an electric field therebetween. In this regard, the state of the areas of the display medium 10 underneath the designated first loop conductors 220 may be changed, and thereby writing messages on the designated areas of the display medium 10.

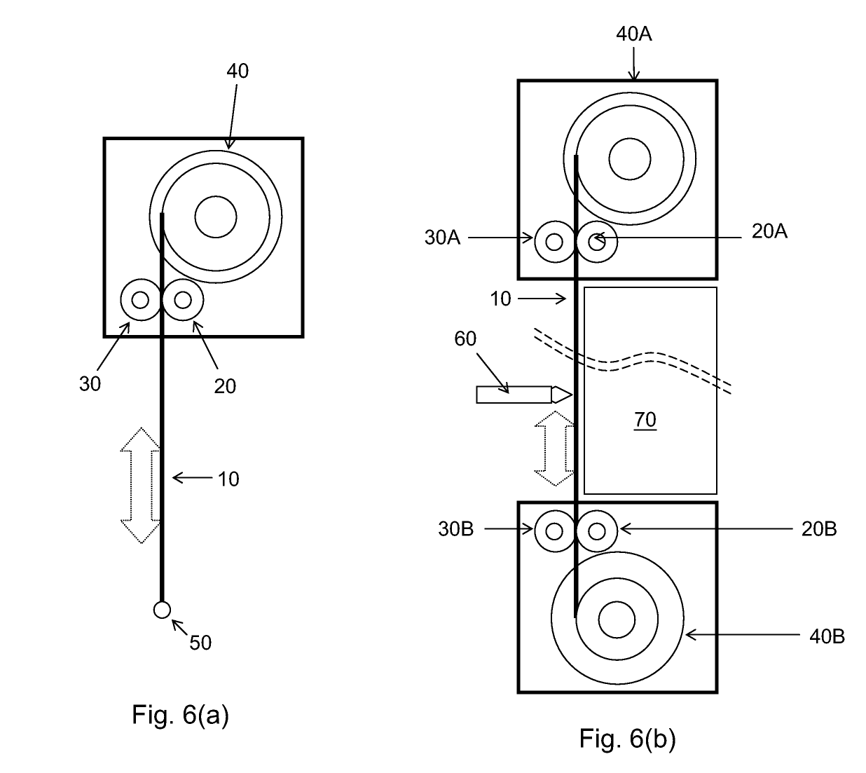

FIGS. 6(a) and 6(b) are exemplary cross-sectional views of application of a display unit in examples consistent with the present invention. In FIG. 6(a), a display unit may include a case 40 for winding and storing the display medium 10 like a film and rewinding the drawn-out display medium 10. The display unit may further include a writehead 20 and a support unit 30 at both sides of the display medium 10. A weight element 50 may be included at one end of the display medium 10 as shown at FIG. 6(a) to keep the display medium 10 smooth. Similar to FIG. 6(a), the display unit of FIG. 6(b) may include two sets of a case 40 for winding and storing a display medium 10, a writehead 20, and a support unit 30. For both FIGS. 6(a) and 6(b), the case 40 may be, for example, a cylindrical case. The case 40 may include a guide to ensure that the display medium 10 is drawn out and rewound smoothly. In addition, an object, such as an optical or touching pen 60, may write on the display medium 10. As shown in FIG. 6(b), a pen 60 may write on a display medium 10 with a wall 70 behind the medium 10. Winding or rewinding the display medium 10 may be accomplished manually or by a drive mechanism. In one example, the drive mechanism may control rotation of at least one of the writehead 20 and the support unit 30. The rotation may result in movement of the display medium 10. In another example, the drive mechanism may move the display medium 10. The movement of the display medium 10 may result in rotation of the writehead 20 and the support unit 30.

It will be appreciated by those skilled in the art that changes could be made to the examples described above without departing from the broad inventive concept thereof. It is understood, therefore, that this invention is not limited to the particular examples disclosed, but it is intended to cover modifications within the spirit and scope of the present invention as defined by the appended claims.

We claim:

1. A display unit, comprising:
a display medium which is writable, erasable and configured to display an image, wherein the display medium is capable of maintaining a written image without power; and
a rotatable writehead including a body, portions of which include a number of loop conductors parallel with each other,
wherein the display medium and the writehead are configured to have no relative motion with respect to each other when writing on the display medium.

2. The display unit according to claim 1, further comprising a drive mechanism to drive at least one of the display medium and the rotatable writehead.

3. The display unit according to claim 1, wherein the display medium comprises a bistable material layer.

4. The display unit according to claim 1, wherein the display medium is made of at least one of a cholesteric liquid crystal imaging film, an electrophoretic imaging film and an electrowetting imaging film.

5. The display unit according to claim 3, wherein the display medium comprises a first electrode layer.

6. The display unit of claim 3, wherein the display medium comprises at least one of a first electrode layer, an absorbing layer and a protection layer over the bistable material layer.

7. The display unit according to claim 1, wherein the loop conductors include a number of first loop conductors and a number of second loop conductors.

8. The display unit according to claim 1, wherein the writehead further comprises insulation layers to cover portions of the writehead that are not covered by the loop conductors.

9. The display unit according to claim 1, wherein the loop conductors contact the display medium when writing on the display medium.

10. The display unit of claim 1 further comprising a processing unit to receive signals to be written from at least one of wired connection and wireless connection, the processing unit electrically coupled to the loop conductor.

11. The display unit according to claim 1, wherein the display unit is a flexible display unit.

12. The display unit according to claim 1, wherein the rotatable writehead is in a polygonal cylindrical shape.

13. A display unit, comprising:
a display medium which is writable, erasable and configured to display an image, wherein the display medium is capable of maintaining a written image without power;
a rotatable writehead including a body, portions of which include a number of loop conductors parallel with each other, wherein the loop conductors configure to provide an electric field to an area of the display medium; and
a support unit wherein the rotatable writehead and the support unit are located on both sides of the display medium,
wherein the display medium and the writehead are configured to have no relative motion with respect to each other when writing on the display medium.

14. The display unit according to claim 13, further comprising a drive mechanism to drive at least one of the display medium, the rotatable writehead and the rotatable support unit.

15. The display unit according to claim 13, wherein the display medium comprises a bistable material layer.

16. The display unit according to claim 13, wherein the rotatable support unit comprises a supporting roller including an elastic material over the supporting roller.

17. The display unit according to claim 13, wherein the supporting roller is made of a conductive material.

18. The display unit according to claim 13, wherein the display unit is a flexible display unit.

19. The display unit according to claim 13, wherein the rotatable writehead is in a polygonal cylindrical shape.

20. The display unit according to claim 13, wherein the display medium is configured to move when at least one of the writehead and the support unit rotates.

21. The display according to claim 13, wherein the at least one of the writehead and the support unit are configured to rotate when the display medium moves.

22. A method of writing on a display, the method comprising:
writing on an area of a display medium by applying an electric field to the area;
rotating a writehead such that no relative motion occurs between the display medium and the writehead.

23. The method according to claim 22, wherein a peripheral speed of rotation of the writehead is same as a movement speed of the display medium.

24. The method according to claim 22 comprising rotating the writehead at the same speed as moving the writehead, wherein the rotating is at a peripheral speed of rotation of the writehead and the moving at a movement speed of the writehead.

25. The method according to claim 22, wherein the writehead rotates continuous in angle.

26. The method according to claim 22, wherein the writehead rotates step-by-step in angle.

27. The method according to claim 22, wherein the writehead is in a polygonal cylindrical shape.

28. A writehead, comprising a rotatable body, a portion of which is covered with a number of loop conductors parallel with each other, wherein the loop conductors provide an electric field to an area of a medium for writing on the medium.

29. The writehead according to claim 28, wherein the loop conductors include a number of first loop conductors and a number of second loop conductors.

30. The writehead according to claim 28, further comprising an insulation layers covering portions of the body that are not covered by the loop conductors.

31. The writehead according to claim 28, wherein the loop conductors are in contact with the medium during a writing operation.
